(19) United States
(12) Patent Application Publication
(10) Pub. No.: US 2011/0314423 A1
(43) Pub. Date: Dec. 22, 2011

(54) IMAGE DISPLAY DEVICE AND IMAGE DISPLAY METHOD

(75) Inventors: Hiroyoshi Ohmiya, Osaka (JP); Teruo Koukai, Nara (JP); Toshiyuki Tanaka, Osaka (JP); Kouichi Kanemura, Osaka (JP)

(73) Assignee: PANASONIC CORPORATION, Kadoma-shi, Osaka (JP)

(21) Appl. No.: 13/203,776

(22) PCT Filed: Mar. 10, 2010
(86) PCT No.: PCT/JP2010/001696

§ 371 Date: Aug. 29, 2011

(30) Foreign Application Priority Data
Mar. 12, 2009 (JP) 2009 059066
Apr. 22, 2009 (JP) 2009 103570

(51) Int. Cl. G06F 3/048

(52) U.S. Cl. 715/845

(57) ABSTRACT

An image display device includes an image generator, a controller, and a display unit. The image generator generates a guide image which is to be displayed differently with a lapse of time to change the sequential selection mode to the skip selection mode when a user input indicates a long press on a same key over the period which determines that the user input indicates a long key press and the sequential selection mode is moved into the skip selection mode. The controller controls the image generator to generate the guide image. The display unit displays the guide image.

THIS APPLICATION IS A U.S. NATIONAL PHASE APPLICATION OF PCT INTERNATIONAL APPLICATION NO. PCT/JP2010/001696.

### TECHNICAL FIELD

The present invention relates to an image display device and an image display method for allowing the user to select a desired one of a plurality of objects displayed in a screen.

### BACKGROUND ART

Unlike personal computers, many household electrical appliances do not have a mouse. In most such appliances, when selecting a desired one of objects (such as menu items or thumbnail images) displayed in the screen, the user moves the cursor using the four-way multi-selector of a remote control (for example, Patent Literature 1). When, however, there are a large number of objects displayed in the screen, it is extremely troublesome for the user to make a selection using the cursor.

To solve this problem, the following image recording devices have been developed (for example, Patent Literature 2). When the user pushes down and holds a key, the cursor moves through thumbnail images sequentially at an accelerated rate. If the user continues to hold down the key when the cursor is on the final thumbnail image in a page, the next page is displayed. If the user further continues to hold down the key, the cursor is prevented from moving through each thumbnail image, and instead, the subsequent page is displayed.

In this conventional technique, if the user pushes down and holds an operation key when the cursor is on one of objects (such as menu items or thumbnail images) displayed in the screen, the cursor moves through the objects sequentially at first. Then, if the user continues to hold down the operation key for a predetermined time or more, the cursor is prevented from moving through each object, and is instead allowed to skip predetermined number of objects.

This conventional technique, however, is not user-friendly in the following situations. To make the cursor skip some objects, the user is not sure how long he/she should hold down the operation key. In contrast, to make the cursor move through the objects sequentially by holding down the operation key, the user has to release the operation key before the cursor skips some objects, but cannot predict its timing.

### CITATION LIST

### Patent Literature

Patent Literature 1: Japanese Patent Unexamined Publication No. 2001-231014
Patent Literature 2: Japanese Patent Unexamined Publication No. 2003-324671

### SUMMARY OF THE INVENTION

The image display device of the present invention has a sequential selection mode and a skip selection mode in order to select one of a plurality of objects based on a user input. The sequential selection mode is a mode in which one of the plurality of objects is selected sequentially when a predetermined key is pushed down. The skip selection mode is a mode in which one of the plurality of objects is selected by skipping predetermined number of objects when the predetermined key is pushed down. The image display device includes an image generator, a controller, and a display unit. The image generator generates a guide image which is to be displayed differently with a lapse of time in order to change the sequential selection mode to the skip selection mode when the user input indicates a long press on a same key as the predetermined key over a period. This period is used to determine that a user input indicates a long key press and the sequential selection mode is moved into the skip selection mode. The controller controls the image generator to generate the guide image. The display unit displays the guide image.

With this structure, when the user input is determined to be a long key press, the image display device changes the guide image with time. This allows the user to predict the time remaining until the cursor starts skipping some objects.

The image display method of the present invention has a sequential selection mode and a skip selection mode in order to select one of a plurality of objects based on a user input. The sequential selection mode is a mode in which one of the plurality of objects is selected sequentially when a predetermined key is pushed down. The skip selection mode is a mode in which one of the plurality of objects is selected by skipping predetermined number of objects when the predetermined key is pushed down. The image display method includes an image generation step and a image display step. The image generation step generates a guide image which is to be displayed differently with a lapse of time in order to change the sequential selection mode to the skip selection mode when the user input indicates a long press on the same key as the predetermined key over a period. This period is used to determine that the user input indicates a long key press and the sequential selection mode is moved into the skip selection mode. The image display step displays the guide images in the image generation step.

### BRIEF DESCRIPTION OF DRAWINGS

FIG. 1 is a block diagram of an image display device according to a first exemplary embodiment of the present invention.

FIG. 2 shows key states of an operation key of a remote control in the first exemplary embodiment of the present invention.

FIG. 3 is a flowchart showing the operating procedure of the image display device according to the first exemplary embodiment of the present invention.

FIG. 4 shows an example of a menu image, a cursor image, and a guide image appearing on the display unit of the image display device according to the first exemplary embodiment of the present invention.

FIG. 5 is a flowchart showing the operating procedure of an image display device according to a second exemplary embodiment of the present invention.

FIG. 6 shows an example of a menu image, a cursor image, and a guide image appearing on the display unit of the image display device according to the second exemplary embodiment of the present invention.

FIG. 7 is a flowchart showing the operating procedure of an image display device according to a third exemplary embodiment of the present invention.

FIG. 8 shows an example of a menu image, a cursor image, and a guide image appearing on the display unit of the image display device according to the third exemplary embodiment of the present invention.

FIG. 9 is a block diagram of an image display device according to a fourth exemplary embodiment of the present invention.

FIG. 10 is a block diagram of another example of the image display device according to the fourth exemplary embodiment of the present invention.

FIG. 11 shows an example of a menu image, a cursor image, and a guide image appearing on the display unit of the image display device according to the fourth exemplary embodiment of the present invention.

FIG. 12 is a flowchart showing the operating procedure of the image display device according to the fourth exemplary embodiment.

FIG. 13 shows an example of a menu image, a cursor image, and a guide image appearing on the display unit of the image display device according to a fifth exemplary embodiment of the present invention.

FIG. 14 is a flowchart showing the operating procedure of the image display device according to the fifth exemplary embodiment of the present invention.

FIG. 15 is a flowchart showing the operating procedure of an image display device according to a sixth exemplary embodiment of the present invention.

FIG. 16 is a flowchart showing the operating procedure of an image display device according to a seventh exemplary embodiment of the present invention.

### DETAILED DESCRIPTION OF PREFERRED EMBODIMENTS

### First Exemplary Embodiment

Embodiments of the image display device of the present invention will be described as follows with reference to accompanied drawings. When components denoted by the same reference numerals operate in the same manner in these embodiments, the operation may not be described repeatedly.

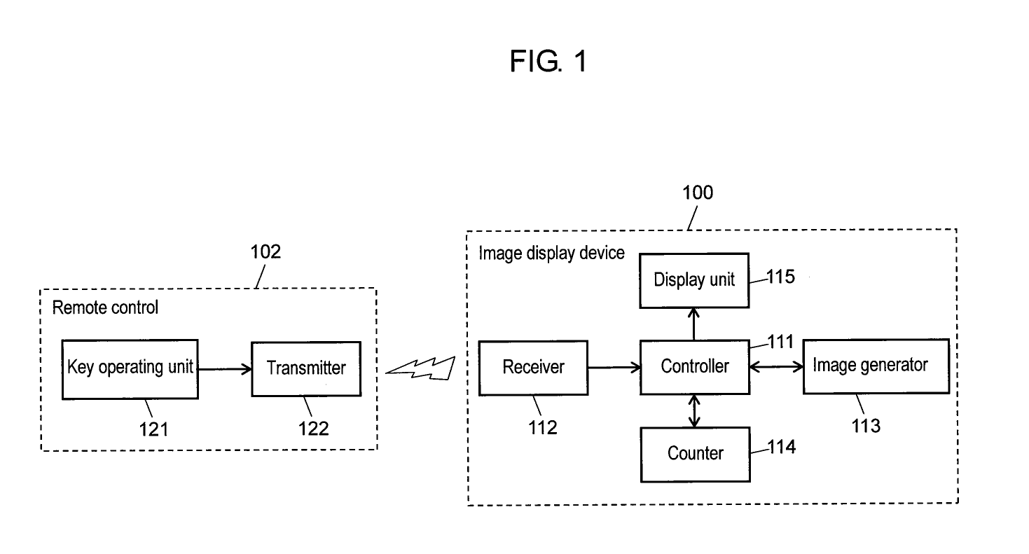

FIG. 1 is a block diagram of image display device 100 according to a first exemplary embodiment of the present invention. In FIG. 1, image display device 100 of the present exemplary embodiment includes controller 111, receiver 112, image generator 113, counter 114, and display unit 115. Remote control 102 includes key operating unit 121 and transmitter 122.

Key operating unit 121 has an operation key such as a four-way multi-selector. When the user pushes down the operation key, key operating unit 121 transmits key state information to transmitter 122. Transmitter 122 transmits the key state information to image display device 100.

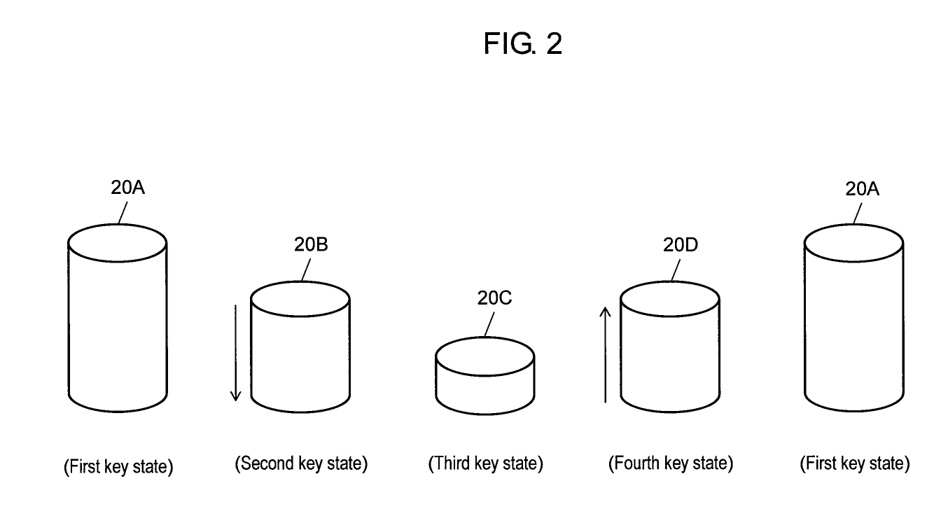

FIG. 2 shows key states of the operation key of remote control 102 in the first exemplary embodiment when the user operates key operating unit 121. The operation key changes its state in the order of first, second, and third key states 20A, 20B, and 20C. First key state 20A is when the user is not operating the operation key. Second key state 20B is when the user has started to push down the operation key. Third key state 20C is when the user has completely pushed down the operation key. When the user releases the operation key, third key state 20C changes to fourth key state 20D, and then to first key state 20A.

When the operation key goes into first, second, third, or fourth state 20A, 20B, 20C, or 20D, key operating unit 121 transmits key state information to transmitter 122 to inform it of the respective key states. Third key state 20C indicating that the operation key has been pushed down may be transmitted as “key-ON” in the key state information. On the other hand, first, second, and fourth key states 20A,20B, and 20D indicating that the operation key is not pushed down may be transmitted as “key-OFF”.

Upon receiving key state information from transmitter 122, receiver 112 of image display device 100 transmits the received key state information to controller 111. Upon receiving, for example, third key state 20C, controller 111 initializes counter 114 to make counter 114 measure the duration of third key state 20C (that is, the time during which the user is holding down the operation key).

Controller 111 controls cursor movement, instructs image generator 113 to generate a guide image, and controls the generated guide image based on the received key state information and the measurement results of counter 114. Thus, controller 111 controls display unit 115 to display a menu image, a cursor image, and a guide image.

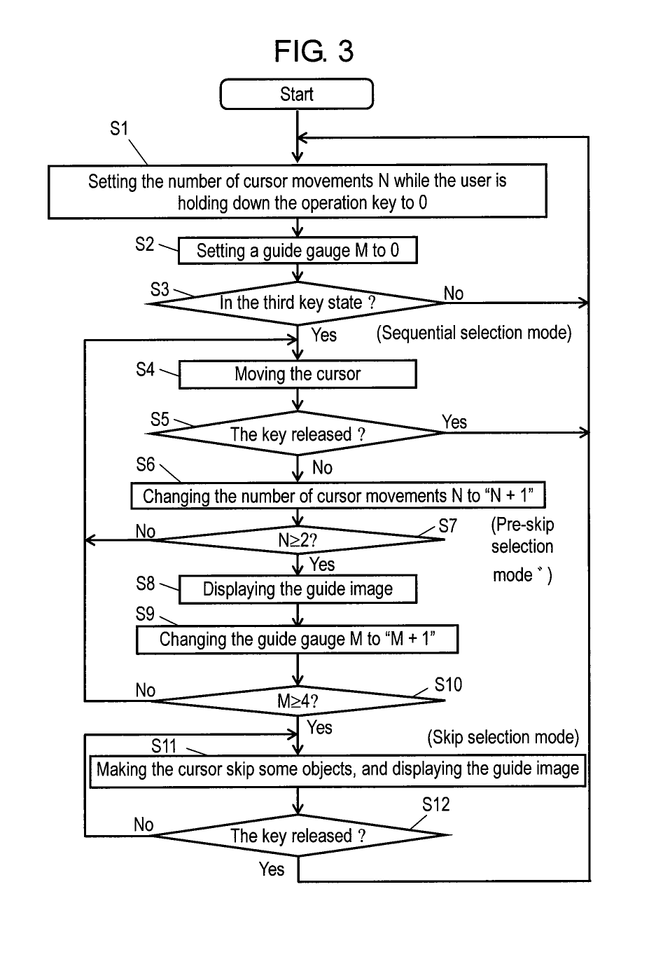

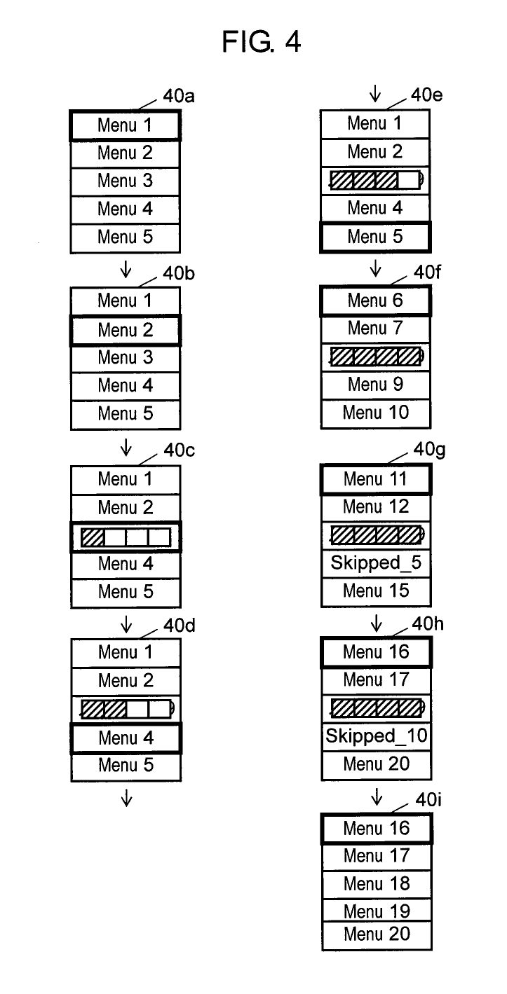

The following is a description, with reference to FIGS. 3 and 4, of the operating procedure of image display device 100 in the present first exemplary embodiment, particularly how to display a menu image, a cursor image, and a guide image in the screen. FIG. 3 is a flowchart showing the operating procedure of image display device 100 of the first exemplary embodiment. The process of controller 111 is classified into a sequential selection mode, a pre-skip selection mode, and a skip selection mode. The sequential selection mode is a mode in which a plurality of objects is selected sequentially based on the key input by the user. The skip selection mode is a mode in which one of the plurality of objects is selected by skipping predetermined number (n) of objects. These modes will be described in detail later. FIG. 4 shows an example of a menu image, a cursor image, and a guide image appearing on display unit 115 of image display device 100 of the first exemplary embodiment. This example shows a transition from display screens 40a through 40i according to a procedure described later.

For easier explanation, each screen includes five menu items arranged in a single vertical column, and the cursor moves only downward to select a menu item based on the key input by the user (in this case, the user pushes the down key of the four-way multi-selector of remote control 102). Thus, the following description assumes that the user pushes the down key of the four-way multi-selector of remote control 102.

When the user pushes the down key of remote control 102, display screen 40a appears on display unit 115. Display screen 40a shows a list of menu items (menus 1 to 5) as a menu image. The cursor is on menu 1. The cursor is shown as a solid frame indicating a selected menu item (such as “menu 1”). As described above, image display device 100 of the present exemplary embodiment has the function of selecting one of a plurality of objects such as menu items based on a user input.

The operating procedure of image display device 100 of the present exemplary embodiment will be described as follows with reference to FIG. 3. Controller 111 sets the number of cursor movements N of counter 114 to 0 while the user is holding down the operation key (Step S1). Controller 111 also sets a guide gauge M to the initial value 0 (Step S2). Controller 111 determines whether the operation key is in third key state 20C (Step S3). When the determination is negative (No in Step S3), the process returns to Step S1 to repeat the steps taken so far.

When the control key is in third key state 20C (Yes in Step S3), on the other hand, the process proceeds to Step S4 where controller 111 moves the cursor one position down (Step S4). As a result, the cursor is on menu 2 in display screen 40b on display unit 115.

After moving the cursor one position down (Step S4), controller 111 determines whether the user has released the down key (Step S5). When the determination is affirmative (Yes in Step S5), the process returns to Step S1 to determine again whether a control key is in third key state 20C (Step S3).

Having determined that the user is still holding down the down key (No in Step S5), controller 111 changes the number of cursor movements N of counter 114 to “N+1” while the user is holding down the operation key (Step S6). In this case, controller 111 may have a proper waiting time before the process proceeds to Step S7. This allows image display device 100 to have an appropriate response time to determine whether the user is still holding down the operation key.

Controller 111 determines whether or not the number of cursor movements N is not less than 2 while the user is holding down the operation key (Step S7). When the number is less than 2 (No in Step S7), the process returns to Step S4 to repeat the steps taken so far. These steps are the operations performed by image display device 100 when controller 111 is in the sequential selection mode.

When the number of cursor movements N is 2 or more while the user is holding down the operation key, controller 111 determines that the user is performing a long press on the down key (Yes in Step S7), and enters the pre-skip selection mode. Controller 111 instructs image generator 113 to generate a guide image, and makes the guide image appear on display unit 115 (Step S8). More specifically, when the user is holding down a same key as the down key over a period to determine whether it is a long key press or not, controller 111 determines that the user is performing a long press on the operation key. In this case, the period indicates the time after the key state is first detected and until the cursor is set on menu 3. Controller 111 then makes the guide image appear on display unit 115 (Step S8). As shown in display screen 40c on display unit 115, the cursor is on menu 3 and the guide image is displayed. In this case, controller 111 may have a proper waiting time before the process proceeds to Step S9. This allows image display device 100 to have an appropriate response time to change the guide image.

Controller 111 changes the guide gauge M of counter 114 to “M+1” (Step S9), and determines whether or not the guide gauge M is not less than 4 (Step S10). When the determination is negative (No in Step S10), the process returns to Step S4 to repeat the steps taken so far.

Every time Steps S4 through S9 are repeated, controller 111 moves the cursor one position down, and increases the guide gauge M of the guide image by one. As a result, the guide image appears differently as shown in display screens 40d, 40e, and 40f on display unit 115.

As described above, having determined that the user input indicates a long press on the same key as the predetermined key over the period to determine whether a user input indicates a long key press or not, controller 111 of image display device 100 in the present exemplary embodiment generates a guide image which is to be displayed differently with a lapse of time. Then, display unit 115 displays the guide image differently with a lapse of time.

When the guide gauge M is 4 or more (Yes in Step S10), controller 111 enters the skip selection mode. Controller 111 makes the cursor skip a predetermined number “n” (in this case, n is 5) of objects, instead of moving the cursor down each object, and also makes the guide image displayed (Step S11). Controller 111 determines whether the user has released the down key (Step S12). Having determined that the user is still holding down the down key (No in Step S12), controller 111 repeatedly makes the cursor skip some objects and makes the guide image displayed (Step S11). When it is determined that the user has released the down key (Yes in Step S12), the process returns to Step S1.

On display unit 115, the cursor is on menu 6 in display screen 40f where the guide gauge M of the guide image is 4, which is the upper limit. The cursor then moves to menu 11 in display screen 40g (by skipping five menu items) from the state shown in display screen 40f. If the user continues to hold down the down key, the cursor moves to menu 16 in display screen 40h (by skipping five menu items). These steps are repeated until the user is determined to have released the down key. In other words, the cursor skips some objects repeatedly in these steps.

Thus, if the user continues to hold down the down key after he/she has been determined to be performing a long press on the operation key (Step S5) and then after the time to wait for the cursor to skip some objects has elapsed (Step S10), controller 111 prevents the cursor from moving down each object. The term “the time to wait” means the time after the guide image is displayed and until the guide gauge M reaches 4.

Controller 111 makes the cursor skip the predetermined number “n” (in this case, n is 5) of objects (Step S11). When the user is not determined to have released the down key (No in Step S12), controller 111 again makes the cursor skip some objects (Step S11). Having determined that the user is performing a long press on the operation key, controller 111 makes the guide image displayed differently according to the response time for the change in the guide gauge M during the time to wait for the cursor to skip some objects. In other words, having determined that the user input is a long key press and that there is no other user input, controller 111 generates a guide image which is to be displayed differently between when it is determined that there is no other user input and when a time has passed since it was determined that there is no other user input.

Having determined that the user has released the down key (Yes in Step S12), on the other hand, controller 111 prevents the cursor from skipping. The process returns to Step S1 where controller 111 determines again whether a control key is in third key state 20C. When the user is determined to have released the down key after the cursor skipped to menu 16 on display unit 115, the cursor remains on menu 16, and the guide image disappears. As a result, display screen 40i appears on display unit 115. Thus, having determined that the user is performing a long key press and that there is no other user input, controller 111 erases the guide image generated when it is determined that there is no other user input.

As described hereinbefore, according to image display device 100 of the present exemplary embodiment, when the user continues to holding down an operation key over the period to determine whether it is a long key press or not, the guide gauge M of the guide image is increased with time. This allows the user to properly predict the time remaining until the cursor starts skipping some objects. As a result, when not wanting the cursor to skip, the user understands the timing to release the operation key before the cursor starts skipping some objects. Thus, image display device 100 provides increased user-friendliness.

### Second Exemplary Embodiment

In image display device 100 of the first exemplary embodiment, when the user releases the down key after the cursor skips some objects, controller 111 prevents the cursor from skipping, and erases the guide image. In the present exemplary embodiment, on the other hand, when the user releases the down key after the guide image is displayed, controller 111 starts to decrease the guide gauge M. If the user again pushes down and holds the operation key over the period to determine whether it is a long key press or not before the guide gauge M becomes 0 and the guide image disappears, controller 111 starts to increase the guide gauge. Controller 111 makes the cursor skip some objects also in the present exemplary embodiment.

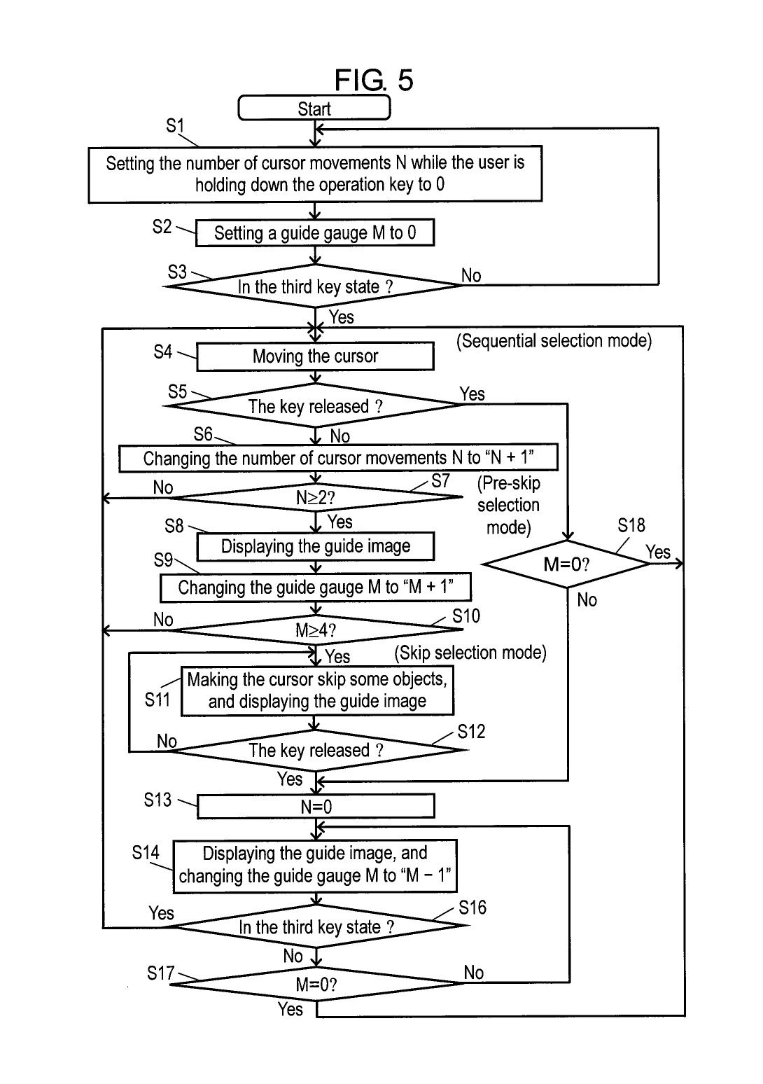

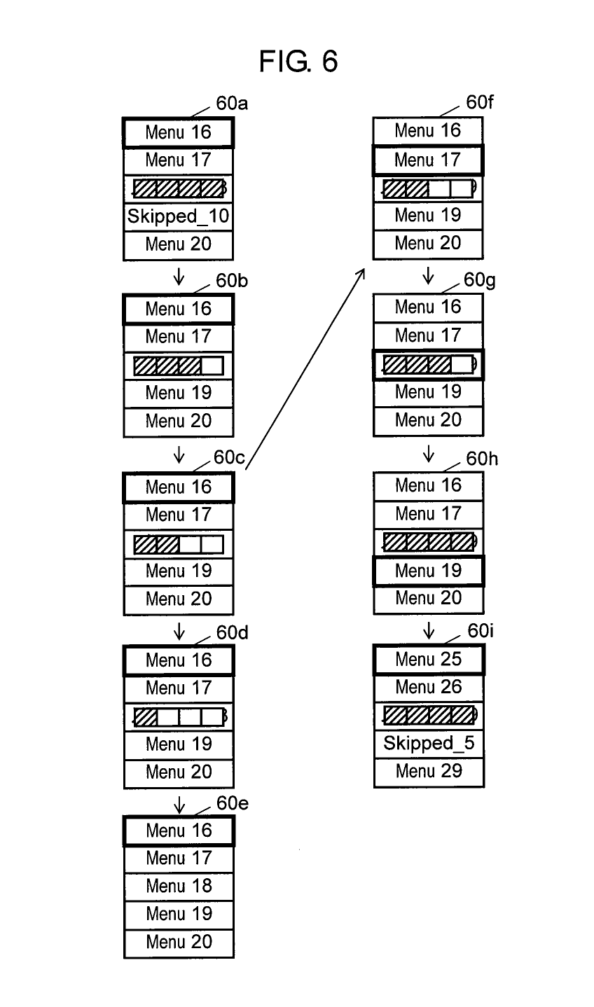

FIG. 5 is a flowchart showing the operating procedure of image display device 100 according to the second exemplary embodiment of the present invention. FIG. 6 shows an example of a menu image, a cursor image, and a guide image displayed on display unit 115 of image display device 100 according to the second exemplary embodiment. This example shows a transition from display screens 60a through 60i according to a procedure described later. Display screen 60a shows a state where the cursor skips some objects (Step S11). Steps S1 to S12 will not be described because they are identical to those in the first exemplary embodiment.

Controller 111 determines whether the user has released the down key (Step S12). When it is determined that the user is still holding down the down key (No in Step S12), the process returns to Step S11 where the cursor skips some objects repeatedly. Having determined that the user has released the down key (Yes in Step S12), on the other hand, controller 111 sets the number of cursor movements N to 0 while the user is holding down the operation key (Step S13). Then, controller 111 makes the guide image appear on display unit 115, and decreases the guide gauge M of the guide image by one. In other words, the guide gauge M is changed to “M−1” (Step S14). As a result, display screen 60b appears on display unit 115.

Controller 111 determines whether the down key is in third key state 20C (Step S16). When the down key is not in third key state 20C (No in Step S16), controller 111 determines whether the guide gauge M is 0 (Step S17). When the guide gauge M is not 0 (No in Step S17), the process returns to Step S14. Unless the down key is determined to be in third key state 20C in Step S16, the operations in Steps S14 to S17 are repeated until the guide gauge M becomes 0 in Step S17. These operations are shown in display screens 60c, 60d, and 60e.

When, on the other hand, controller 111 determines that the down key is in third key state 20C (Yes in Step S16), the process returns to Step S4 where controller 111 moves the cursor (Step S4). Controller 111 determines whether the user has released the down key (Step S5). Having determined that the user has released the down key (Yes in Step S5), controller 111 determines whether the guide gauge M is 0 (Step S18). When the guide gauge M is not 0 (No in step S18), the process proceeds to Step S13. When, on the other hand, the guide gauge M is 0 (Yes in Step S18), the process returns to Step S4.

Display screen 60f appears when the gauge M in display screen 60c is decreased by one in Step S14; the down key is detected to be in third key state 20C (Yes in Step S16); and the cursor is moved (Step S4). If the user is still holding down the down key (No in Step S5), and is determined to be performing a long key press (Yes in Step S7), controller 111 again increases the guide gauge M (Step S9) as shown in display screens 60g and 60h. When the guide gauge M reaches the upper limit 4, controller 111 makes the cursor skip some objects as shown in display screen 60i.

As described hereinbefore, according to image display device 100 of the present exemplary embodiment, when the user releases the down key after the cursor skips some objects, the guide gauge M starts to be decreased. If the user again pushes down and holds the down key before the gauge M becomes 0 and the guide image disappears, the guide gauge M is increased with time. This allows the user to properly predict the time remaining until the cursor starts skipping some objects. As a result, when not wanting the cursor to skip, the user understands the timing to release the operation key before the cursor starts skipping some objects. Thus, image display device 100 provides increased user-friendliness.

### Third Exemplary Embodiment

In the first exemplary embodiment, when the user continues to hold down the down key even after the cursor skips some objects, the cursor skip some objects repeatedly. In the present exemplary embodiment, on the other hand, when the user continues to hold down the down key cursor even after the cursor skips some objects, the guide gauge M is decreased first and is then increased to make the cursor skip some objects again.

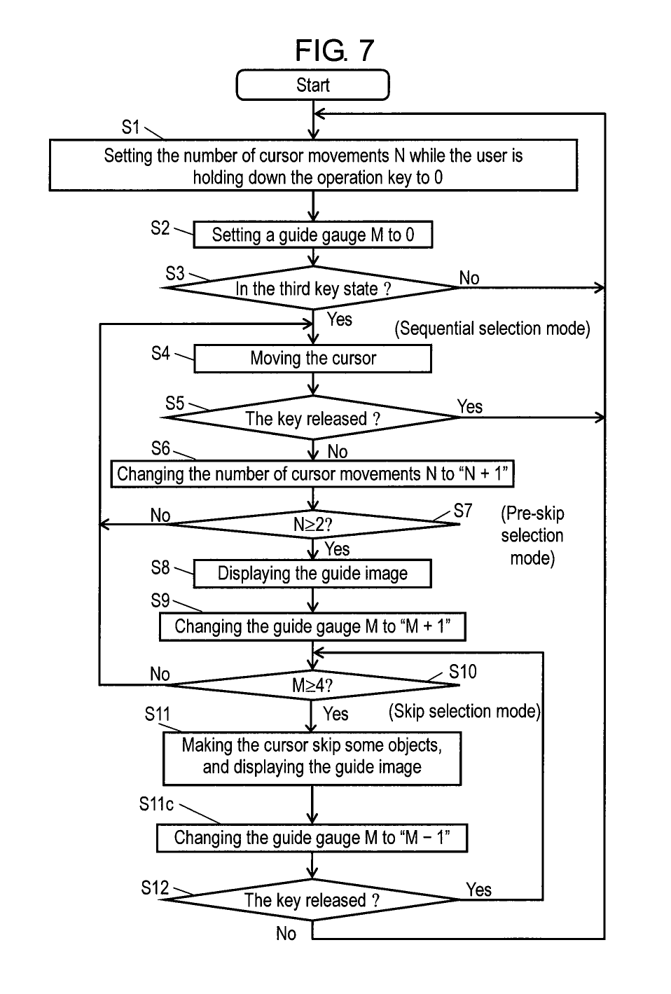

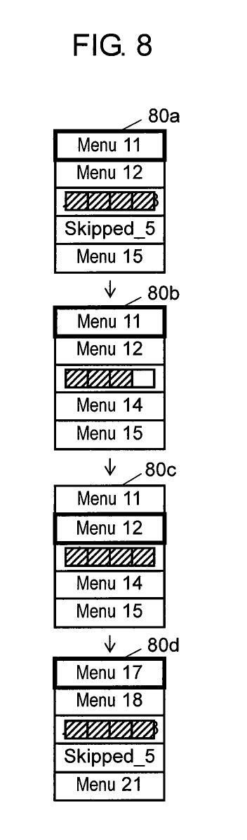

FIG. 7 is a flowchart showing the operating procedure of image display device 100 according to the third exemplary embodiment of the present invention. FIG. 8 shows an example of a menu image, a cursor image, and a guide image displayed on display unit 115 of image display device 100 according to the third exemplary embodiment. This example shows a transition from display screens 80a through 80d according to a procedure described later. Display screen 80a shows a state where the cursor has skipped some objects (Step S11). Steps S1 to S11 will not be described because they are identical to those in the first exemplary embodiment.

Immediately after the cursor skips some objects, controller 111 makes a guide image appear on display unit 115 (Step S11). Controller 111 decreases the guide gauge M by one, that is, changes the guide gauge M to “M−1” (Step S11c), and determines whether the user has released the down key (Step S12). After these operations, display screen 80b appears on display unit 115. When the user has released the down key (Yes in Step S12), the process returns to Step S10. When the guide gauge M is determined to be less than 4 (No in Step S10), the process returns to Step S4.

Controller 111 moves the cursor one position down (Step S4). When the user is determined to be performing a long press on the down key (Yes in Step S7), the guide image is displayed (Step S8), and the guide gauge M is increased by one (Step S9). When the guide gauge M is determined to be 4 or more (Yes in Step S10), the cursor is made to skip some objects again. These operations are shown in display screens 80c and 80d.

As described hereinbefore, according to image display device 100 of the present exemplary embodiment, when the user continues to hold down the down key even after the cursor skips some objects, the guide gauge is decreased first and is then increased to make the cursor skip some objects again. This allows the user to properly predict the time remaining until the cursor starts skipping some objects. As a result, when not wanting the cursor to skip, the user understands the timing to release the operation key before the cursor starts skipping some objects. Thus, image display device 100 provides increased user-friendliness.

Image display device 100 is a separate component from remote control 102 having key operating unit 121 in the first to third exemplary embodiments, but they may be integrated into each other.

Display unit 115 of image display device 100 may be a separate component from controller 111 of image display device 100.

The guide image in the present exemplary embodiment is one example, and may have other display conditions such as color, brightness, size, or shape.

The menu items shown in the present exemplary embodiment are one example, and may be arranged differently such as in multiple rows or in multiple columns.

The objects on display unit 115 are not limited to menu items, but may be, for example, images taken with a digital still camera.

### Fourth Exemplary Embodiment

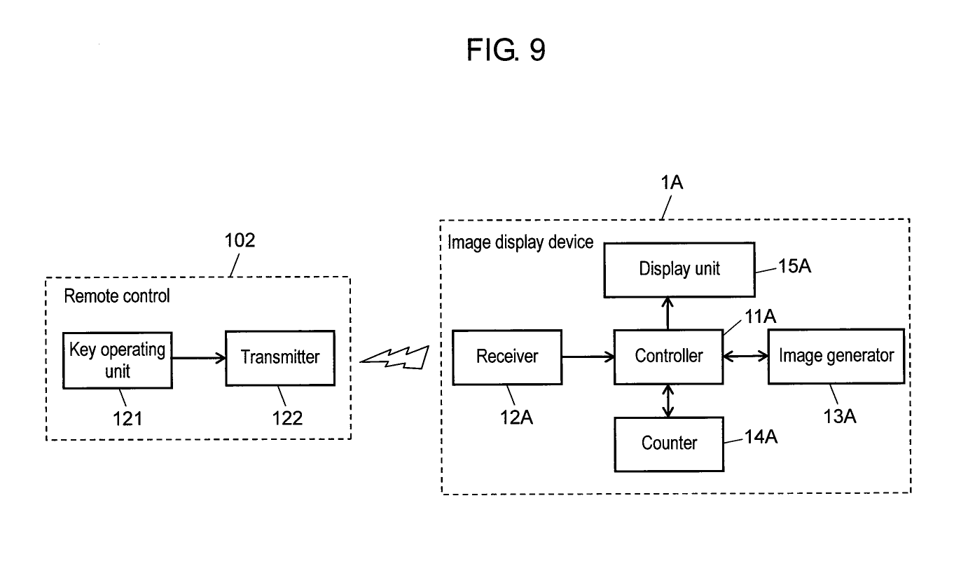

FIG. 9 is a block diagram of image display device 1A according to a fourth exemplary embodiment of the present invention. In FIG. 9, image display device 1A includes controller 11A, receiver 12A, image generator 13A, counter 14A, and display unit 15A. Remote control 102, which sends a command to image display device 1A, includes key operating unit 121 and transmitter 122.

Key operating unit 121 has an operation key such as a four-way multi-selector. When the user pushes down the operation key, key operating unit 121 transmits key state information to transmitter 122. Transmitter 122 transmits the key state information to image display device 1A. The key state information indicates either “key-ON” where the operation key is in the pushed state or “key-OFF” where the operation key is not in the pushed state.

Upon receiving key state information from transmitter 122, receiver 12A of image display device 1A transmits the received key state information to controller 11A. Upon receiving the key state information, controller 11A initializes counter 14A, detects a change from key-OFF to key-ON, measures the time elapsed before key-ON after the initialization of counter 14A, instructs image generator 13A to move the cursor and to generate a guide image. Controller 11A also makes display unit 15A display a cursor image and a guide image. Image generator 13A generates a menu image, a cursor image, and a guide image.

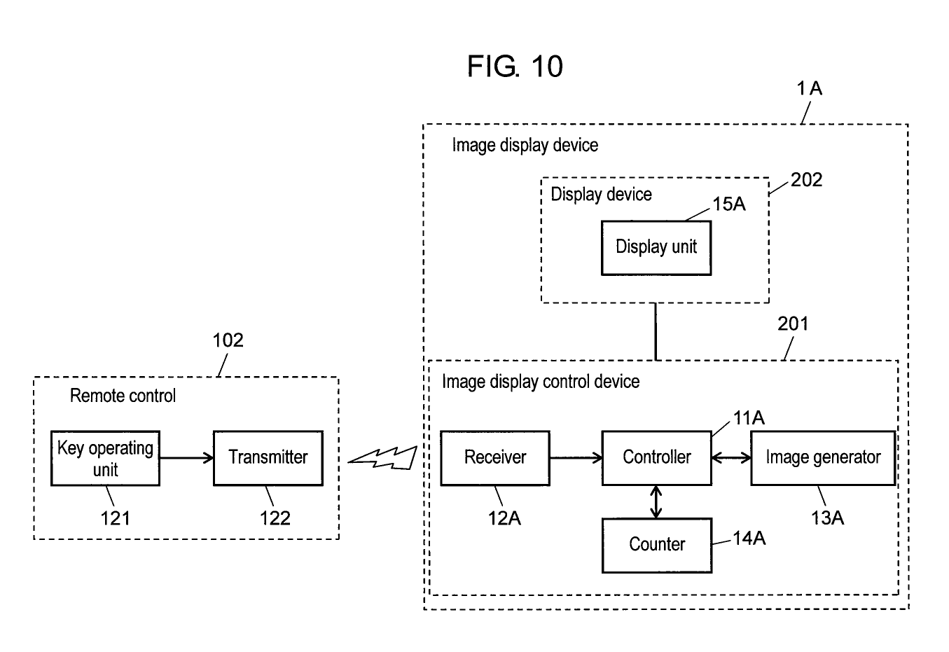

Image display device 1A shown in FIG. 9 may alternatively be composed of two different components: image display control device 201 and display device 202 as shown in FIG. 10. Image display control device 201 includes controller 11A, receiver 12A, image generator 13A, and counter 14A. Display device 202 receives and displays an image transmitted wired or wirelessly from controller 11A of image display control device 201. In the following description, image display device 1A has the structure shown in FIG. 9.

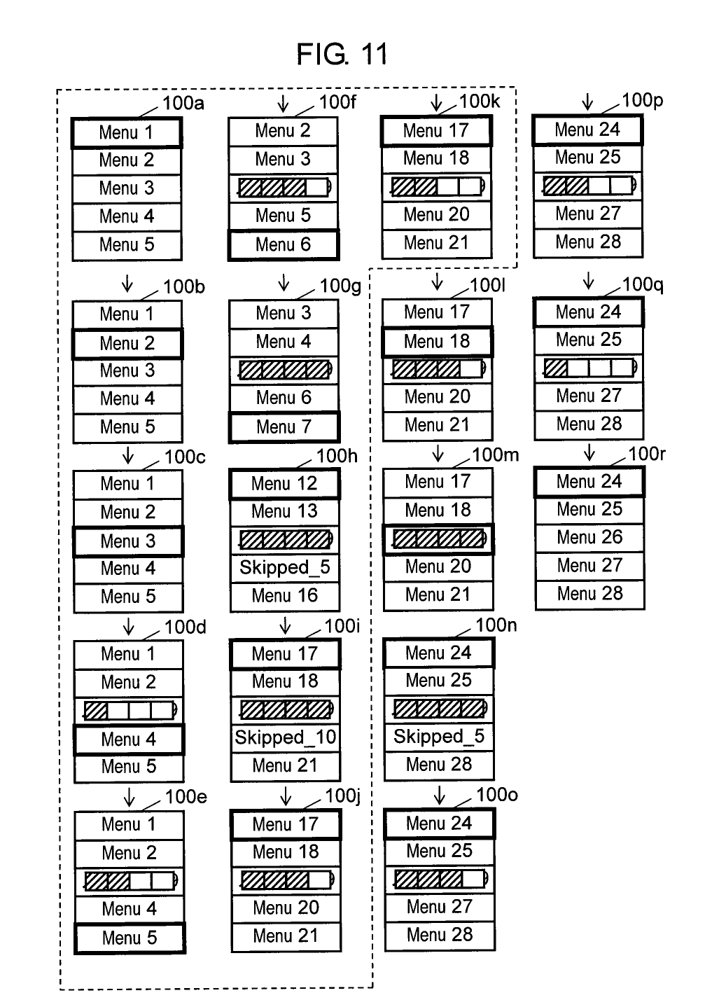

FIG. 11 shows an example of each of a menu image, a cursor image, a guide image appearing on display unit 15A of image display device 1A according to the fourth exemplary embodiment. This example shows a transition from display screens 100a through 100r according to a procedure described later. Each screen on display unit 15A includes five menu items arranged in a single vertical column, and the cursor moves only downward to select a menu item based on the key input by the user (in this case, the user pushes the down key of the four-way multi-selector of remote control 102). The cursor is shown as a solid frame indicating a selected menu item (such as “menu 1”).

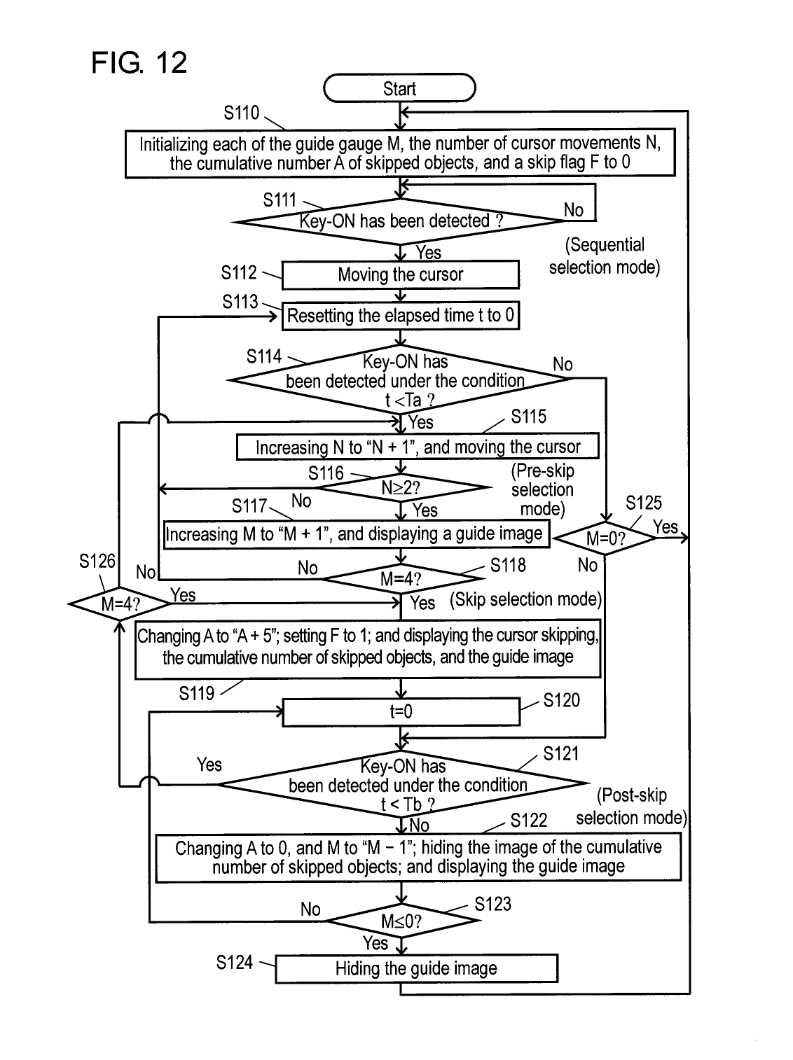

FIG. 12 is a flowchart showing the operating procedure of image display device 1A according to the fourth exemplary embodiment. The process of controller 11A is classified into a sequential selection mode, a pre-skip selection mode, a skip selection mode, and a post-skip selection mode. The sequential selection mode is a mode in which a plurality of objects is selected sequentially based on the key input by the user. The skip selection mode is a mode in which one of the plurality of objects is selected by skipping predetermined number “n” of objects. The predetermined number “n” is 5 in the present exemplary embodiment. These modes will be described in detail later.

When the user pushes a menu-selection-mode button (not shown), information for menu selection is supplied from transmitter 122 of remote control 102 to controller 11A via receiver 12A of image display device 1A. As a result, the procedure of the flowchart shown in FIG. 12 is started, and display screen 100a shown in FIG. 11 appears as the initial screen.

Image display device 1A performs the following procedure in the sequential selection mode. In FIG. 12, in Step S110, controller 11A initializes each of the guide gauge M, the number of cursor movements N, the cumulative number A of skipped objects, and a skip flag F to 0. In Step S111, controller 11A waits for the next key-ON. Upon detection of key-ON, the process proceeds to Step S112 where controller 11A moves the cursor to menu 2. Image generator 13A generates a guide image and outputs it to controller 11A. Controller 11A makes the guide image appear on display unit 15A as shown in display screen 100b.

In Step S113, controller 11A resets counter 14A to 0, allowing counter 14A to start counting the elapsed time “t”. In Step S114, controller 11A determines whether key-ON has been detected before the elapsed time “t” of counter 14A reaches Ta, that is, under the condition t<Ta. Ta is a predetermined time such as 0.5 or 1 second. To determine whether key-ON has been detected under the condition t<Ta, controller 11A may determine whether Tk<Ta. Tk is a value of the elapsed time “t” measured by counter 14A when the key state information received from receiver 12A has changed from key-OFF to key-ON. Controller 11A continues the determination in Step S114 until up to the time Ta. If key-ON is not detected within the time Ta, the determination is negative in Step S114, and the process proceeds to Step S125. The procedure after Step S125 will be described later.

When the determination is affirmative in Step S114, controller 11A enters the pre-skip selection mode, which is a preparation for the skip selection mode. In Step S115, controller 11A increases the number of cursor movements N by one to make N=1, and makes the cursor move down to menu 3 as shown in display screen 100c. In Step S116, controller 11A determines whether the condition N≧2 is satisfied. Since N=1, the determination is negative, and the process returns to Step S113. Upon detection of key-ON under the condition t<Ta by the operations in Steps S113 and S114, controller 11A makes the condition N=2 satisfied, and moves the cursor to menu 4 as shown in display screen 100d in Step S115. Since N=2, the determination is affirmative in Step S116. In Step S117, controller 11A increases M to “M+1”, and makes the guide image displayed. More specifically, in Step S117, controller 11A increases M from 0 to 1, and makes image generator 13A generate a guide image showing a guide gauge M=1, and makes the guide image appear on display unit 15A.

A guide image indicates how many more times the user should perform the key-ON operation within the predetermined time (t<Ta) for controller 11A to enter the skip selection mode. The horizontal bar chart shown in menu 3 in display screen 100d is a gauge image as a guide image. The gauge of the gauge image in the present exemplary embodiment has four scales. The scales indicate how many times the user should perform the key-ON operation within the predetermined time (t<Ta) for controller 11A to enter the skip selection mode from the sequential selection mode. The gauge is hatched or colored in the first one scale (25%) when M=1; in the first two scales (50%) when M=2; in the first three scales (75%) when M=3; and in all four scales (100%) when M=4. The regions without hatching or coloring indicate how many more times the user should perform the key-ON operation within the predetermined time (t<Ta) for controller 11A to enter the skip selection mode. When M=4, the gauge is hatched or colored 100%, indicating that image display device 1A is in the skip selection mode.

In display screen 100d, since M=1, the gauge image corresponds to one-fourth (25%). This gauge image informs the user that if he/she performs the key-ON operation three more times within the predetermined time (t<Ta), controller 11A enters the skip selection mode.

In Step S118, controller 11A determines whether the guide gauge M=4. Since M=1, that is, M<4, the determination is negative, and the process returns to Step S113. Upon detection of key-ON under the condition t<Ta by the operations in Steps S113 and S114, N=3 in Step S115. In Step S116, the determination is affirmative. In Step S17, since M=2, the cursor moves to menu 5 as shown in display screen 100e. The screen indicating that the guide gauge M is 2 appears on display unit 15A. Display screen 100e informs the user that if he/she performs the key-ON operation two more times within the predetermined time (t<Ta), controller 11A enters the skip selection mode.

In Step S118, controller 11A determines whether the guide gauge M=4. Since M=2, that is, M<4, the determination is negative, and the process returns to Step S113. Upon detection of key-ON under the condition t<Ta by the operations in Steps S113 and S114, N=4 in Step S115. In Step S116, the determination is affirmative. In Step S117, since M=3, the cursor moves to menu 6 as shown in display screen 100f. The screen indicating that the guide gauge M is 3 appears on display unit 15A. Display screen 100f informs the user that if he/she performs the key-ON operation one more time within the predetermined time (t<Ta), controller 11A enters the skip selection mode.

In Step S118, controller 11A determines whether the guide gauge M=4. Since M=3, that is M<4, the determination is negative, and the process returns to Step S113. Upon detection of key-ON under the condition t<Ta by the operations in Steps S113 and S114 (Yes in Step S114), N=5 in Step S115. In Step S116, the determination is affirmative. In Step S117, since M=4, the cursor moves to menu 7 as shown in display screen 100g. The screen indicating that the guide gauge M is 4 appears on display unit 15A. Display screen 100g informs the user that controller 11A enters the skip selection mode.

In Step S118, controller 11A determines whether the guide gauge M=4. When the determination is affirmative, controller 11A enters the skip selection mode. Since the determination is affirmative in Step S118 on display screen 100g, the process proceeds to Step S119 where controller 11A makes the cursor skip some objects for the first time. In Step S119, controller 11A changes A to “A+5”; sets F to 1; and displays the cursor skipping, the cumulative number of skipped objects, and the guide image. More specifically, as shown in display screen 100h, the cumulative number A of skipped objects is increased by 5 to make A=5; the skip flag F is set to 1; and the cursor is skipped to menu 12. Display screen 100h further includes the image of the cumulative number A of skipped objects, and the gauge image hatched or colored 100%. The cursor has skipped from menu 7 appearing in display screen 100g to menu 12 by five objects. The image “Skipped_{—}5” appears in the fourth position from the top indicating that the cursor has skipped five objects. The gauge image remains the same because the guide gauge M=4.

Since it usually takes a very short time to perform the operation in Step S119, screen display 100g appears only for a moment before screen display 100h appears.

In Step S120, controller 11A resets counter 14A to 0, allowing counter 14 to start counting the time “t”. In Step S121, controller 11A determines whether key-ON has been detected under the condition t<Tb. Tb is a predetermined time such as 1 or 2 seconds. The relation between Ta and Tb will be described later. If the user wants the cursor to continue to skip some objects, the user pushes the key under the condition t<Tb. As a result, controller 11A detects key-ON, and the determination is affirmative in Step S121. The process proceeds to Step S126 where the determination is affirmative because the guide gauge M=4. The process returns to Step S119.

In Step S119 again, controller 11A changes the cumulative number A of skipped objects to “A+5=10”; and displays the cursor skipping and the cumulative number of skipped objects. More specifically, as shown in display screen 100i, the cursor has skipped from menu 12 to menu 17 by five objects, and the cumulative number of skipped objects is displayed as “Skipped_{—}10”. The gauge image remains the same because the guide gauge M=4.

Hereinafter, every time the user pushes down the key under the condition t<Tb, the cursor continues to skip every five objects.

To stop the cursor from skipping every five objects, the user can refrain from performing the key-ON operation within the predetermined time (t<Tb). In this case, the determination is negative in Step S121, and the process proceeds to Step S122 where controller 11A enters the post-skip selection mode. In Step S122, controller 11A changes the cumulative number A of skipped objects to 0, and the guide gauge M to “M−1”; hides the image of the cumulative number of skipped objects; and displays the guide image. More specifically, as shown in display screen 100j, controller 11A erases the display of “Skipped_A” because the cumulative number A of skipped objects is 0, and changes the gauge of the gauge image to 75% because the guide gauge M=“4−1=3”. The cursor remains on menu 17.

In Step S123, the determination is negative because the guide gauge M=3, and the process returns to Step S120. Unless controller 11A detects key-ON within the predetermined time (t<Tb) in Step S121, the loop from Steps S120 to S123 is repeated. The guide gauge M is decreased one by one as follows: the gauge of the gauge image is 50% on display screen 100k; 25% on the next display screen (not shown); and 0% on the next display screen (not shown). When the guide gauge M=0, the determination is affirmative in Step S123, and the process proceeds to Step S124. In Step S124, controller 11A hides the guide image. The cursor remains on menu 17. The process returns to Step S110 where controller 11A waits for the next key-ON.

The loop process including the operation of Step S119 is referred to as the skip selection mode because the cursor skips some objects. The loop process including the operations of Steps S115 and S117 is referred to as the pre-skip selection mode because it is a preparation for the skip selection mode. The loop process including the operation of Step S122 is referred to as the post-skip selection mode because the detection of key-ON is not performed within the predetermined time (t<Tb) and the cursor does not skip any objects after the skip selection mode.

The following is a description of the operation to change from display screen 100l through 100r. If controller 11A detects key-ON under the condition t<Tb in Step S121 during the post-skip selection mode, the process proceeds to Step S126. In Step S126, if M≠4, the determination is negative, and the process returns to Step S115. In Step S115, controller 11A enters the pre-skip selection mode. Assume that controller 11A detects key-ON under the condition t<Tb in Step S121 when the guide gauge M is decreased to 2 as in display screen 100k. In this case, the determination is negative in Step S126, and the process returns to Step S115. In Step S115, controller 11A makes the condition N=3 satisfied, and moves the cursor by one position to menu 18. In Step S117, controller 11A changes M to “2+1=3”, and makes a guide image displayed. The gauge of the gauge image is increased by 25% to 75%, and display screen 100k is changed to display screen 100l. In Step S118, the determination is negative because M=3, and the process returns to Step S113. If controller 11A detects the next key-ON under the condition t<Ta in Step S114, the process proceeds to Step S115. The cursor moves to menu 19 in Step S115, and the guide image where the guide gauge M=4 is displayed in S117. Display screen 100l is changed to display screen 100m. In Step S118, the determination is affirmative because the guide gauge M=4, and controller 11A enters the skip selection mode.

In Step S119, in the skip selection mode, controller 11A changes A to “A+5”; sets F to 1; and displays the cursor skipping, the cumulative number of skipped objects, and a guide image on display unit 15A. More specifically, the cursor moves to menu 19, the guide gauge M is 4, and the cumulative number A of skipped objects is 5. Display screen 100m is changed to display screen 100n. Unless the user performs the key-ON operation within the predetermined time (t<Tb), controller 11A enters the post-skip selection mode. As shown in display screens 100o, 100p, 100q, and 100r, a decrease in the guide gauge M is displayed in the guide image, and the process returns to Step S110.

The change from display screen 100l to 100r can also occur in the following case: after controller 11A once enters the pre-skip selection mode, the next key-ON is performed under the condition Ta≦t<Tb. In Step S114, the determination is negative because controller 11A does not detect the next key-ON under the condition t<Ta, and the process proceeds to Step S125. In Step S125, the determination is negative because the guide gauge M≠0, and the process proceeds to Step S121. In Step S121, when key-ON is performed under the condition Ta≦t<Tb, the determination is affirmative because this means that key-ON is detected within the predetermine time t<Tb. In this case, the process proceeds to Step S115 via Step S126. The cursor moves to menu 19 in Step S115, and a guide image where the guide gauge M=4 is displayed in S117. Display screen 100l is changed to 100m. In Step S118, the determination is affirmative because the guide gauge M=4, and controller 11A enters the skip selection mode. In Step S119, controller 11A changes A to “A+5”; sets F to 1; and displays the cursor skipping, the cumulative number of skipped objects, and the guide image on display unit 15A. More specifically, as shown in display screen 100n, the cursor is on menu 19, the guide gauge M is 4, and the cumulative number A of skipped objects is 5.

In the skip selection mode, when the user performs key-ON after a while, that is, under the condition t≧Tb, controller 11A once enters the post-skip selection mode. Controller 11A, however, returns to the pre-skip selection mode if the user performs key-ON under the condition t<Tb before the guide image disappears. This is because key-ON is detected under the condition t<Tb in Step S121. The time until the guide image disappears is about 4Tb because of the following reason. If controller 11A does not detect key-ON by the time “t” reaches the time Tb in Step S121, controller 11A performs the operations in Steps S122 and S123. Therefore, the loop in the post-skip selection mode is a cycle of about the time Tb. If the user waits for the time 4Tb until M changes from 4 to 0, controller 11A can return from the skip selection mode to the sequential selection mode. The sequential selection mode will be described later.

In the pre-skip selection mode, when the user performs key-ON after a while, that is, under the condition t≧Tb, controller 11A once enters the post-skip selection mode. Controller 11A, however, returns to the pre-skip selection mode if the user performs key-ON under the condition t<Tb before the guide image disappears. This is because key-ON is detected under the condition t<Tb in Step S121. The gauge decreases during that time, causing the user to perform the key-ON operation more number of times under the condition t<Tb for controller 11A to enter the skip selection mode.

The following is a description of the sequential selection mode. Assume that controller 11A detects key-ON in Step S111, and that the user performs the key-ON operation after a while, that is, under the condition t≧Ta. In this case, the determination is negative in Step S114, and the process proceeds to Step S125. When the guide gauge M=0, the determination is affirmative in Step S125, and the process returns to Step S110. In the loop process where the process returns to Step S110 from Step S111 via Step S125, the cursor moves from one menu to another in Step S112. This is the sequential selection mode in which the key-ON operation is repeated at relatively large time intervals.

When the process returns to Step S110 from Step S124, the user has enough time to perform the key-ON operation to move the cursor, which has been set on menu 17 in the skip selection mode, from one menu to another until the desired menu is reached.

As described above, when the user performs the key-ON operation too late to satisfy the condition t<Ta in the pre-skip selection mode in which M=1 to 3, the determination is negative in Step S114, and the process proceeds to Step S125. Since M≠0, the determination is negative in Step S125, and the process proceeds to Step S121. Even if the user performs the key-ON operation late enough to satisfy the condition t≧Ta, as long as the key-ON operation is performed under the condition t<Tb, the determination is affirmative in Step S121. In Step S126, the determination is negative because M≠4 (M=1 to 3), and the process returns to Step S115. Thus, the pre-skip selection mode can be maintained when the user performs key-ON under the condition t<Tb even if it is not quick enough to satisfy the condition t<Ta. Thus, even if the user fails to perform the key-ON operation quickly, controller 11A can manage to enter the skip selection mode in most cases.

In image display device 1A of the present exemplary embodiment, the user needs to perform the key-ON operation quickly enough to satisfy the condition t<Ta only to change the sequential selection mode to the pre-skip selection mode. After this, the user can perform the key-ON operation late enough to satisfy the condition t<Tb (Ta<Tb) in the pre-skip selection mode and the skip selection mode. Therefore, even if the user fails to perform the key-ON operation quickly, this is not considered as an operational failure. Thus, mage display device 1A is user-friendly to those who cannot operate keys quickly.

In Step S116, the condition N≧2 can be replaced by the condition N≧1. In this case, the number of times of the key-ON operation that the user performs in the pre-skip selection mode can be reduced by one.

In the above description, a gauge image in a guide image appears in the third of the menu image consisting of five menu items. The gauge image is preferably translucent such that the user can see the menu behind it. The gauge image may be any shape such as a pie graph, instead of a bar chart, and may appear beside the menu instead of on it.

The skip flag F, which is not used in the present exemplary embodiment, may not be processed in the present exemplary embodiment.

In the above-described procedure, controller 11A may be designed to perform the following function. When the cursor is on a menu desired by the user and the user pushes the Enter key (not shown) of remote control 102, controller 11A detects that the Enter key has been pushed, and starts the desired menu by terminating the process shown in the flowchart of FIG. 12.

The number “n” of objects that the cursor skips is predetermined to be 5 by controller 11A in the present exemplary embodiment, but may alternatively be default set in Step S110. Alternatively, the number “n” may be changed by the user.

The following is a detailed description of the detection of key-ON in Steps S114 and S121. In Step S114, controller 11A repeats the step of determining whether the key state information from receiver 12A is key-OFF or key-ON and storing the key state information. Upon detection of a change in the key state information from key-OFF to key-ON, controller 11A stores a counter value Tk of counter 14A obtained at this moment. This process is referred to as a key-ON detection step.

In Step S114, controller 11A repeats the key-ON detection step until “t” reaches a maximum of Ta. If, during this period, the condition Tk<Ta is determined to be satisfied when the counter value Tk is stored at the moment when the key state information is detected to have changed from key-OFF to key-ON, the key-ON is determined to have been detected under the condition t<Ta (Yes in Step S114). Therefore, the key-ON detection step is terminated, and the process proceeds to Step S115. On the other hand, if the key state information does not change from key-OFF to key-ON even when t=Ta, or if the condition Tk<Ta is not satisfied even when a change from key-OFF to key-ON is determined, the determination is negative in Step S114, and the process proceeds to Step S125.

In Step S121, controller 11A repeats the key-ON detection step until “t” reaches a maximum of Tb. If, during this period, a change from key-OFF to key-ON is detected and the condition Tk<Tb is determined to be satisfied, the determination is affirmative because key-ON has been detected under the condition t<Tb. Therefore, the key-ON detection step is terminated, and the process proceeds to Step S126. If the key state information does not change from key-OFF to key-ON even when t=Tb, or if the condition Tk<Tb is not satisfied even when a change from key-OFF to key-ON is determined, the determination is negative in Step S121, and the process proceeds to Step S122.

In the above-described key-ON detection step, key-ON may be immediately detected while Step S121 is in progress. When, however, key-ON is operated in a step other than Step S121, such as Step S122 or S123, the occurrence is detected a little later than it actually occurs while the key-ON detection step is in progress. This means that the time Tk does not necessarily indicate the exact time between a key-ON operation and the next key-ON operation, but the error is negligible when controller 11A operates at a high speed in each step. The exact time of the key-ON operation can be detected by performing a hardware interrupt when a change occurs from key-OFF to key-ON, and by making controller 11A store the counter value Tk of counter 14A.

### Fifth Exemplary Embodiment

In the fourth exemplary embodiment, if the user wants to return to the skip selection mode from the post-skip selection mode in which the gauge of the gauge image is decreasing, the user must once return to the pre-skip selection mode and then perform the key-ON operation to return the gauge of the gauge image to 100%. In the present exemplary embodiment, on the other hand, the user can return to the skip selection mode from the post-skip selection mode without once returning to the pre-skip selection mode.

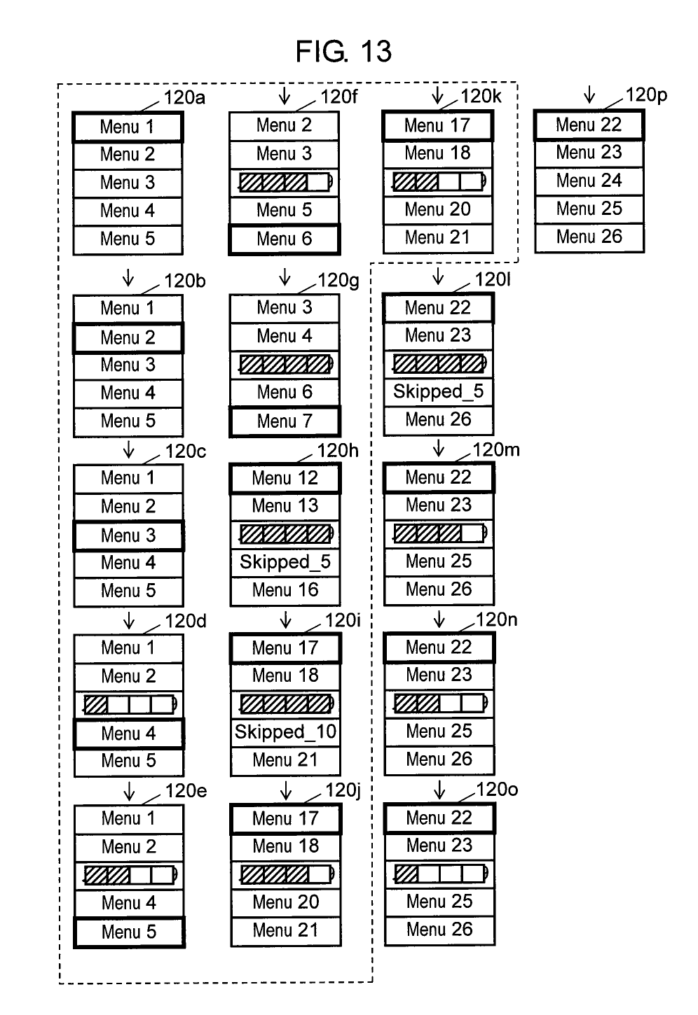

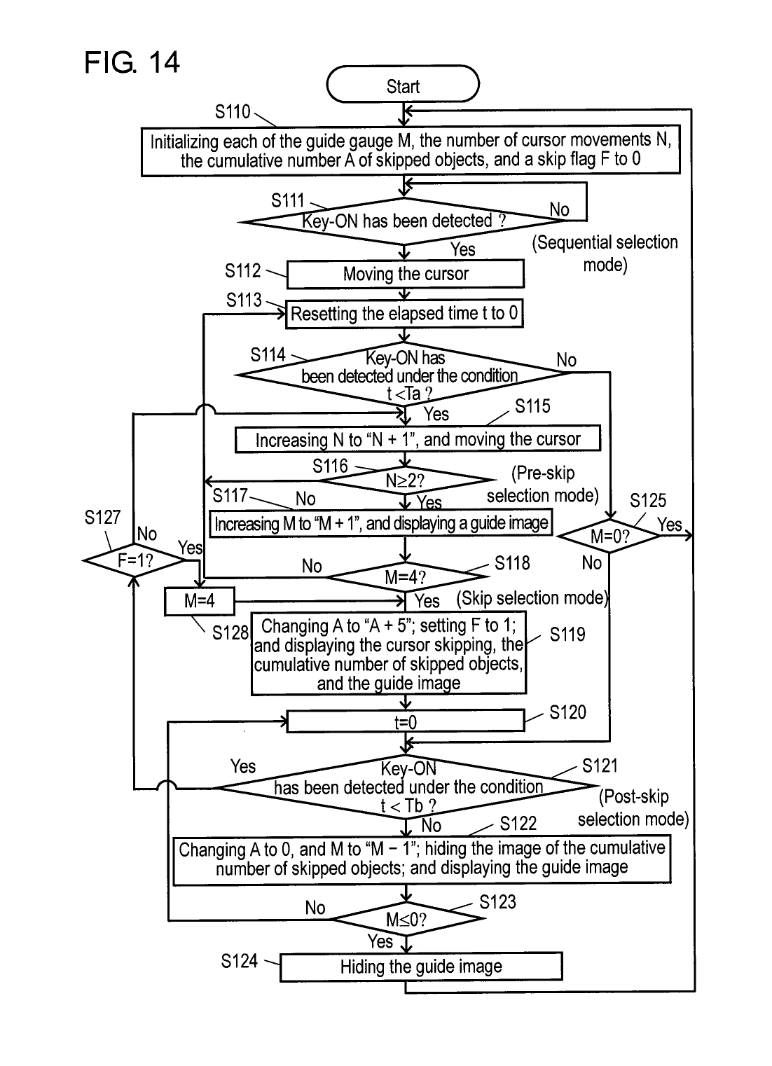

FIG. 13 shows an example of a menu image, a cursor image, and a guide image appearing on display unit 15A of image display device 1A of the fifth exemplary embodiment. FIG. 14 is a flowchart showing the operating procedure of image display device 1A of the present fifth exemplary embodiment. The following description mainly considers the difference between FIG. 12 of the fourth exemplary embodiment and FIG. 14.

When the determination is affirmative in Step S121 in FIG. 14, the process goes to Step S127 where controller 11A determines whether the skip flag F=1. When the skip flag F=0, the determination is negative, and the process proceeds to Step S115, which is in the pre-skip selection mode. When the skip flag F=1, on the other hand, the determination is affirmative, and the process proceeds to Step S128. In Step S128, controller 11A sets the guide gauge M to 4, and the process proceeds to Step S119. When the skip flag F=1 in Step S127, controller 11A can be either in the skip selection mode or in the post-skip selection mode.

In the case where the process proceeds to Step S127 via Steps S120 and S121 after controller 11A changes A to “A+5”; sets F to 1; and displays the cursor skipping, the cumulative number of skipped objects, and the guide image in Step S119, the guide gauge M=4 already. Therefore, the operation for satisfying M=4 in Step S128 is identical to the operations in the skip selection mode described in the fourth exemplary embodiment.

In the case where the process proceeds to Step S127 via Steps S122, S123, S120, and S121, controller 11A is in the post-skip selection mode, and the guide gauge is in the condition of M<4 (M=1 to 3) due to the operation in Step S122. In this case, controller 11A changes the condition M<4 to the condition M=4 in Step S128 to enter the skip selection mode without going through the pre-skip selection mode.

The transition of the display screen according to the above-described operations is described with reference to display screens 120a through 120p shown in FIG. 13. In display screen 120k, controller 11A is in the post-skip selection mode; the cursor is on menu 17; the guide gauge M is decreased to 2; the gauge of the gauge image is 50%; and the cumulative number A of skipped objects is 0. If the user performs the key-ON operation to make the cursor continue to skip some objects, controller 11A detects key-ON under the condition t<Tb. In Step S128, the condition M=4 is satisfied. In Step S119, controller 11A controller 11A changes A to “A”+5”; sets F to 1; and displays the cursor skipping, the cumulative number of skipped objects, and the guide image. More specifically, as shown in display screen 120l, the cursor is on menu 22; the guide gage M is 4; the gauge of the gauge image is 100%; the cumulative number A of skipped objects is 5, and the skip flag F is 1.

To set the gauge of the gauge image to 100% from display screen 120k in the post-skip selection mode, the user needs to perform the key-ON operation twice within the predetermined time (t<Tb) in the fourth exemplary embodiment, but only once in the present exemplary embodiment. When the gauge of the gauge image is at 25% in the post-skip selection mode, the user needs to perform the key-ON operation three times within the predetermined time (t<Tb) in the fourth exemplary embodiment, but just once in the present exemplary embodiment.

In display screens 120m, 120n, 120o, and 120p, no key-ON operation is performed within the predetermined time (t<Tb). As a result, controller 11A enters the post-skip selection mode in which the guide gauge M starts to decrease. When the gauge of the gauge image decreases from 100% to 0%, and controller 11A enters the sequential selection mode in display screen 120p.

### Sixth Exemplary Embodiment

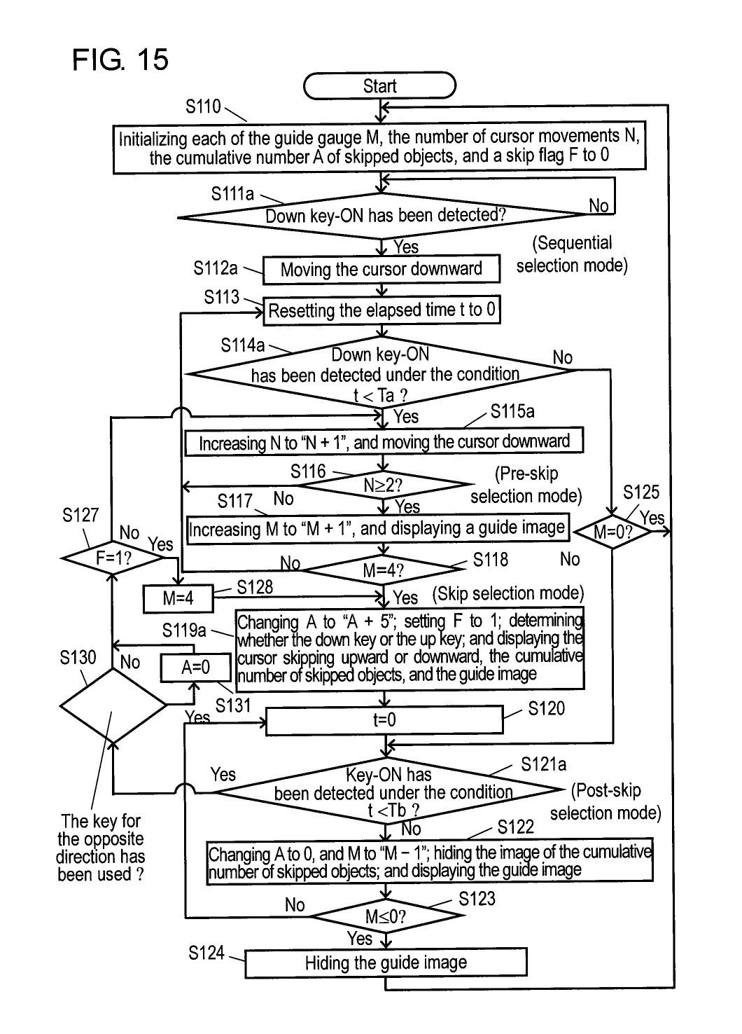

The fifth exemplary embodiment has described the operation of image display device 1A when the user moves the cursor downward to select a menu by pushing the down key of the four-way multi-selector of the remote control. In image display device 1A of the present exemplary embodiment, the user can make the cursor skip some objects upward and downward by using both the down key and the up key in the skip selection mode. FIG. 15 is a flowchart of the present exemplary embodiment. The difference between FIGS. 14 and 15 will be described as follows.

In FIG. 15, upon detection of key-ON in Step S121a, controller 11A determines which of the down key and the up key has been used to perform the key-ON operation, and stores the detection result. Controller 11A also determines whether the key used to perform key-ON is the same as the key used for the last detected key-ON, and stores the detection result.

In Step S119a, controller 11A changes A to “A+5”; sets F to 1; determines whether the key is the down key or the up key; and displays the cursor skipping upward or downward, the cumulative number of skipped objects, and the guide image. More specifically, the cumulative number A of skipped objects is increased by 5; F is set to 1; the cursor is skipped either upward or downward by five menus according to the determination results of the direction of the key used to perform key-ON; the cumulative number A of skipped objects is displayed; and the gauge image as the guide image is displayed.

In step S130, it is determined whether the key for the opposite direction has been used when key-ON is detected in Step S121a. When the key for the opposite direction has not been used, the process proceeds to Step S127; otherwise, the process proceeds to Step S131. In Step S131, controller 11A sets the cumulative number A to 0, and the process proceeds to Step S127.

In Step S119a, controller 11A makes the cursor skip every five menus either upward or downward according to the direction of the pushed key. Thus, the user can make the cursor skip some menus either upward or downward by pushing the down key or the up key.

When the key for the opposite direction is used, the cumulative number A of skipped objects is reset to 0 in Step S131. The next time the cursor skips five menus in Step S119a, the image indicating the cumulative number A of skipped objects disappears, and is replaced by “Skipped_{—}5” indicating that the cumulative number A of skipped objects is set to 5 in the new direction.

In the fourth to sixth exemplary embodiments, the gauge of a gauge image has four scales and is increased or decreased in increments of 25%. Alternatively, the gauge may have three scales and be increased or decreased in increments of one-third, or have two scales and be increased or decreased in increments of 50%. In this case, the number of times of the key-ON operation is reduced, thereby reducing the time to complete the post-skip selection mode.

### Seventh Exemplary Embodiment

The gauge of the gauge image is decreased in increments of 25% in the post-skip selection mode in the fourth to sixth exemplary embodiments, but can be decreased continuously in the present exemplary embodiment. In addition, the speed at which the gauge is decreased can be set to a speed ΔT (<Tb), which is different from the speed determined by the time Tb. In this case, the latency to enter the sequential selection mode via the post-skip selection mode from the skip selection mode can be made 4Tb or less.

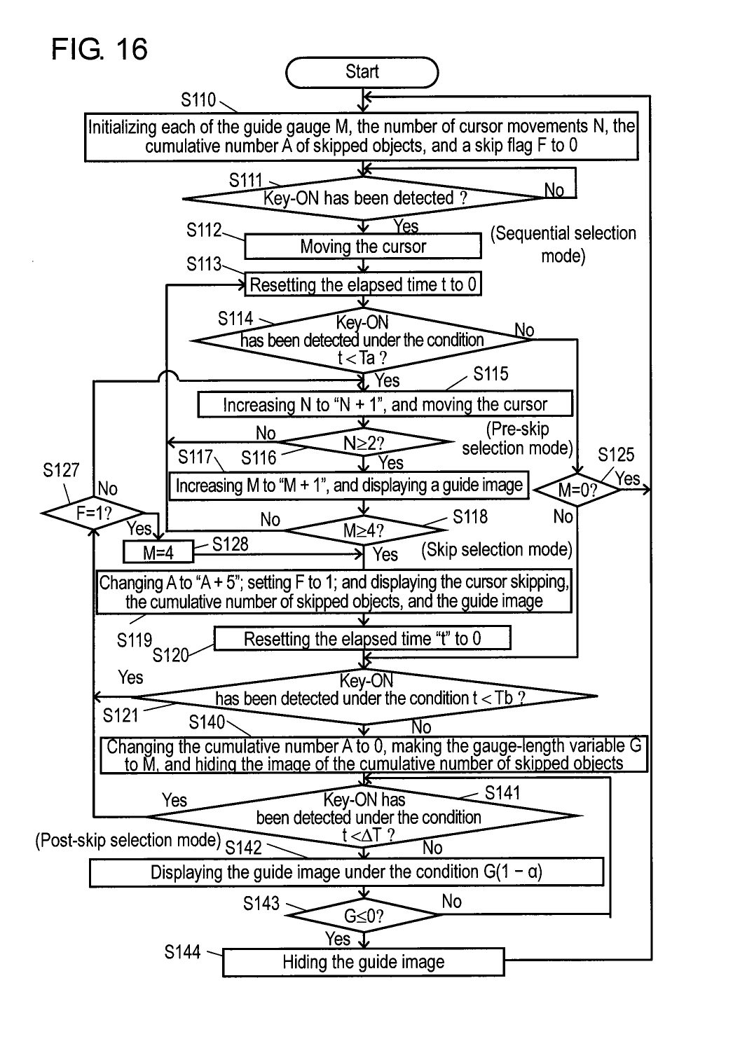

FIG. 16 is a flowchart showing the operating procedure of image display device 1A of the seventh exemplary embodiment in which the gauge is decreased continuously. The following description considers the features of the post-skip selection mode that are different from those in the first to third exemplary embodiments. When the determination is negative in Step S121, the process proceeds to Step S140. In Step s140, controller 11A changes the cumulative number A to 0, sets a gauge-length variable G to M, and hides the image of the cumulative number of skipped objects. The gauge-length variable G means the length of the gauge. The process proceeds to Step S141 where controller 11A determines whether key-ON has been detected under the condition t<ΔT. The determination is usually negative in Step S141 because this is immediately after the determination of Step S121, and the process proceeds to Step S142. In Step S142, controller 11A makes the guide image displayed under the condition G(1−α) where 0≦.α≦1. In this case, the gauge has a length determined by G(1−α). For example, α=0.1. In the case where the guide gauge M=4, the length of the gauge of the gauge image is changed from 100% to (1−α)=0.9, that is 90%. The process proceeds to Step S143 where controller 11A determines whether the gauge-length variable G is 0. When the determination is negative, the process returns to Step S141. Since the gauge image is decreased in increments of 10%, the gauge-length variable G=0 and the determination is affirmative in Step S143 when the time ΔT×10 passes. The process proceeds to Step S144, and then to Step S110 where controller 11A returns to the sequential selection mode. If controller 11A detects a change from key-OFF to key-ON in Step S141, the process proceeds to Step S127, and controller 11A returns to either the pre-skip selection mode or the skip selection mode.

In the case where M=1 to 3, the length of each gauge is decreased in increments of one-tenth. Therefore, the time length until the gauge length becomes 0 and controller 11A returns to the sequential selection mode from the skip selection mode or the pre-skip selection mode is ΔT/α. As “α” decreases, the gauge length is decreased in smaller increments, making the gauge image be decreased smoothly. By adjusting the values ΔT and “α”, the increments in which the gauge length is decreased, and the time until controller 11A returns to the sequential selection mode can be set properly.

In the fourth to seventh exemplary embodiments of the present invention described so far, image display device 1A shown in FIG. 9 or 10 can be composed of hardware components such as an electronic circuit.

The procedure shown in the flowchart of each of the fourth to seventh exemplary embodiments can be implemented by software. The software can be stored in ROM, and be performed by an MPU or on memory. The ROM in this case is preferably non-volatile storage such as a rewritable ROM, but a volatile storage can be used.

The flowcharts shown in the fourth to seventh exemplary embodiments are examples, and image display device 11A and the image display method in the exemplary embodiments of the present invention can be achieved according to other flowcharts.

The menus are arranged vertically in the fourth to seventh exemplary embodiments, but may alternatively be arranged horizontally. In this case, the user selects a menu by using a left key and a right key. It is alternatively possible to make the user select a desired menu from vertically-arranged menus by using the left key and the right key, or from horizontally-arranged menus by using the up key and the down key.

“Skipped_A” indicating the cumulative number A of skipped objects is displayed below a guide image in the fourth to seventh exemplary embodiments, but may alternatively be displayed as “Skipped_{—}5” to inform the user of the number of menus to be skipped at one key-ON operation.

“Skipped_A” is displayed below a guide image in the fourth to seventh exemplary embodiments, but may alternatively be displayed outside the menus.

In the fourth to seventh exemplary embodiments, in the case where controller 11A once moves from the skip selection mode to the post-skip selection mode, and then returns to the skip selection mode,

the cumulative number A of skipped objects may be continued to be displayed as “Skipped_A” instead of being reset.

### INDUSTRIAL APPLICABILITY

The image display device of the present invention is useful when the user selects a desired object from a large number of objects in

mobile telephones, audio-visual devices such as televisions and other household electrical appliances.

### REFERENCE MARKS IN THE DRAWINGS

1A, 100 image display device
102 remote control
11A, 111 controller
12A, 112 receiver
13A, 113 image generator
14A, 114 counter
15A, 115 display unit
121 key operating unit
122 transmitter
201 image display control device
202 display device
n predetermined number

1. An image display device having a sequential selection mode and a skip selection mode in order to select one of a plurality of objects based on a user input, the sequential selection mode being a mode in which the plurality of objects is selected sequentially when a predetermined key is pushed down, the skip selection mode being a mode in which the plurality of objects is selected by skipping every predetermined number of objects when the predetermined key is pushed down, the image display device comprising:
an image generator for generating a guide image which is to be displayed differently with a lapse of time in order to change the sequential selection mode to the skip selection mode when the user input indicates a long press on a same key as the predetermined key over a period which determines that the user input indicates a long key press and the sequential selection mode is moved into the skip selection mode;
a controller for controlling the image generator to generate the guide image; and
a display unit for displaying the guide image.

2. The image display device according to claim 1, wherein
when it is determined that the user input indicates the long press and that there is no other user input, the image generator generates a guide image which is to be displayed differently between when it is determined that there is no other user input and when a time has passed since it was determined that there is no other user input.

3. The image display device according to claim 2, wherein
when it is determined that the user input indicates the long press and that there is no other user input, the image generator erases the guide image generated when it is determined that there is no other user input.

4. The image display device according to claim 2, wherein
the image generator and the controller are separate components from the display unit.

5. An image display method having a sequential selection mode and a skip selection mode in order to select one of a plurality of objects based on a user input, the sequential selection mode being a mode in which the plurality of objects is selected sequentially when a predetermined key is pushed down, the skip selection mode being a mode in which the plurality of objects is selected by skipping every predetermined number of objects when the predetermined key is pushed down, the image display method comprising:
an image generation step for generating a guide image which is to be displayed differently with a lapse of time in order to change the sequential selection mode to the skip selection mode when the user input indicates a long press on a same key as the predetermined key over a period which determines that the user input indicates a long key press and the sequential selection mode is moved into the skip selection mode; and
an image display step for displaying the guide images in the image generation step.

6. The image display method according to claim 5, wherein
when it is determined that the user input indicates the long press and that there is no other user input, the image generation step generates a guide image which is to be displayed differently between when it is determined that there is no other user input and when a time has passed since it was determined that there is no other user input.

7. The image display method according to claim 6, wherein
when it is determined that the user input indicates the long press and that there is no other user input, the image generation step erases the guide image generated when it is determined that there is no other user input.
